(19) United States
(12) Patent Application Publication
(10) Pub. No.: US 2002/0143821 A1
(43) Pub. Date: Oct. 3, 2002

(54) Site mining stylesheet generator

(76) Inventor: Douglas Jakubowski, Oak Hill, VA (US)

Correspondence Address: John W. Ryan, Wilmer, Cutler & Pickering, 2445 M Street, NW, Washington, DC, 20037-1420, US

(21) Appl. No.: 09/736,167

(22) Filed: Dec. 15, 2000

(51) Int. Cl. G06F 15/00

(52) U.S. Cl. 707/522; 707/513

(57) ABSTRACT

A site mining stylesheet may be used to control the presentation of content extracted from a source web page. In particular, a stylesheet stored on a proxy server or the like may be called when a web page associated with the stylesheet is requested by a mobile device. After receiving such a request, the stylesheet extracts the content from the source web page and subsequently transforms and manipulates the extracted content. From there, a destination web page is generated and transmitted to the requesting mobile device for display. The stylesheet may be implemented by first designing a site mining template, This template may be created by receiving and storing format information for formatting a layout of the stylesheet, and an indication of the content to be extracted from the source page. Expressions for uniquely locating each piece of content to be extracted and/or manipulated may also be determined or generated. In addition to the formatting and expression information, the template also includes transformation information for manipulating the specified content. The template may then be converted into a stylesheet and prepared for application to corresponding source web pages.

### FIELD OF THE INVENTION

The present invention relates generally to stylesheets used for mining content from web pages and, more particularly, to the generation of these stylesheets using site mining expressions for uniquely locating content to be extracted and/or transformed.

### BACKGROUND OF THE INVENTION

Organizations of all sizes rely on the Internet to conduct business. Because of the explosion of mobile enterprise solutions, users of wireless or mobile devices are increasingly demanding the delivery of web content for viewing on a variety of platforms ranging from desktop computing units to wireless portable (e.g., handheld) devices such as personal digital assistants (PDAs) and wireless phones. Whether organizations are creating new web applications, or extending existing infrastructure, the new Internet powered world demands that users have access to this content to remain flexible and competitive, and drive stronger customer relationships.

Currently, the appearance of this content varies greatly depending on the platform in which the content is displayed. For example, because of display and bandwidth limitations, a user utilizing a PDA oftentimes cannot access a web page designed for display on a desktop computer, at least not in the manner contemplated by the page designer.

In many cases, certain pieces of content, including memory intensive content such as graphics for example, simply does not need to be displayed to a mobile device user to convey the point of the source page. By displaying only a selected subset of the information from the source page, content may be displayed on a particular platform in a manner that meets the requirements of the requesting device.

A need therefore exists for a technique utilizable for displaying only a specific subset of the source page content (i.e., site mining). A need also exists for a technique that allows the selected content to be transformed or further manipulated before being displayed to the end user. In addition, a need exists for a technique suitable for generating an expression for uniquely locating or identifying the location of content in a page so that the content may be extracted and/or manipulated during the site mining process.

### SUMMARY OF THE INVENTION

The present invention addresses the above and other needs of the prior art by providing a method, system and medium for generating a site mining stylesheet. Generally speaking, site mining stylesheets are utilized to dictate the presentation of information or data on, for example, a screen, display or some form of medium. In addition, embodiments of the present invention contemplate that these stylesheets may be utilized for extracting content from a particular web page. After extraction, this content may be transformed and/or manipulated (using the stylesheet) before being displayed on a mobile device.

In use, the stylesheets may be stored on a proxy server or the like and called when a web page associated with the stylesheet is requested by the mobile device. From there, the stylesheet may be applied to the requested web page to produce a resultant or destination page, which in turn may be transmitted to the requesting mobile device for display. Thus, information or web pages originally designed for display on one device or medium may be altered or reformatted with the addition or omission of data before being presented on another device.

More specifically, embodiments of the invention contemplate first designing a site mining template utilizable for generating the site mining stylesheet. Afterwards, the stylesheet may be applied to a source page to produce a destination page containing any extracted and/or reformatted content from the original source page. This site mining template may be created by receiving and storing format information for formatting a layout of the stylesheet. Similarly, an indication of the content to be extracted from the source page may also be added to the template. To identify the content, an expression for uniquely locating each piece of content to be extracted and/or manipulated may be determined or generated. In addition to this formatting and expression information, transformation information for manipulating the content may be included with the template. Once the template has been completed, it may be converted into the stylesheet and prepared for application to a corresponding source web page. In this manner, the appearance and information presented in a resultant destination page may be customized according to the needs and limitations of a particular device and/or user.

It is to be understood that the invention is not limited in its application to the details of construction and to the arrangements of the components set forth in the following description or illustrated in the drawings. The invention is capable of being implemented in a number of embodiments and of being practiced and carried out in various ways. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The Detailed Description will be best understood when read in reference to the accompanying figures wherein:

FIG. 1 is a block diagram representation of an architecture utilizable for generating a site mining stylesheet according to embodiments of the present invention;

FIG. 2 illustrates one example of a flow diagram depicting the utilization and generation of a stylesheet of the present invention;

FIG. 3 is a flow diagram illustrating an exemplary process utilizable for generating a site mining stylesheet;

FIG. 4 is a flow diagram illustrating an exemplary process utilizable for displaying content contained by a web page;

FIG. 5 is a flow diagram illustrating an exemplary process utilizable for generating a site mining expression for uniquely locating content selected from a web page;

FIG. 6 is a flow diagram illustrating an exemplary process utilizable for generating a site mining expression for uniquely locating content selected from a web page, in which multiple selection criteria are used;

FIG. 7 is a flow diagram illustrating an exemplary process for converting a template into a site mining stylesheet of the present invention;

FIG. 8 illustrates one example of a central processing unit utilizable for implementing a computer process of the present invention; and

FIG. 9 illustrates one example of a block diagram of internal hardware of the central processing unit of FIG. 8.

### DETAILED DESCRIPTION OF THE INVENTION

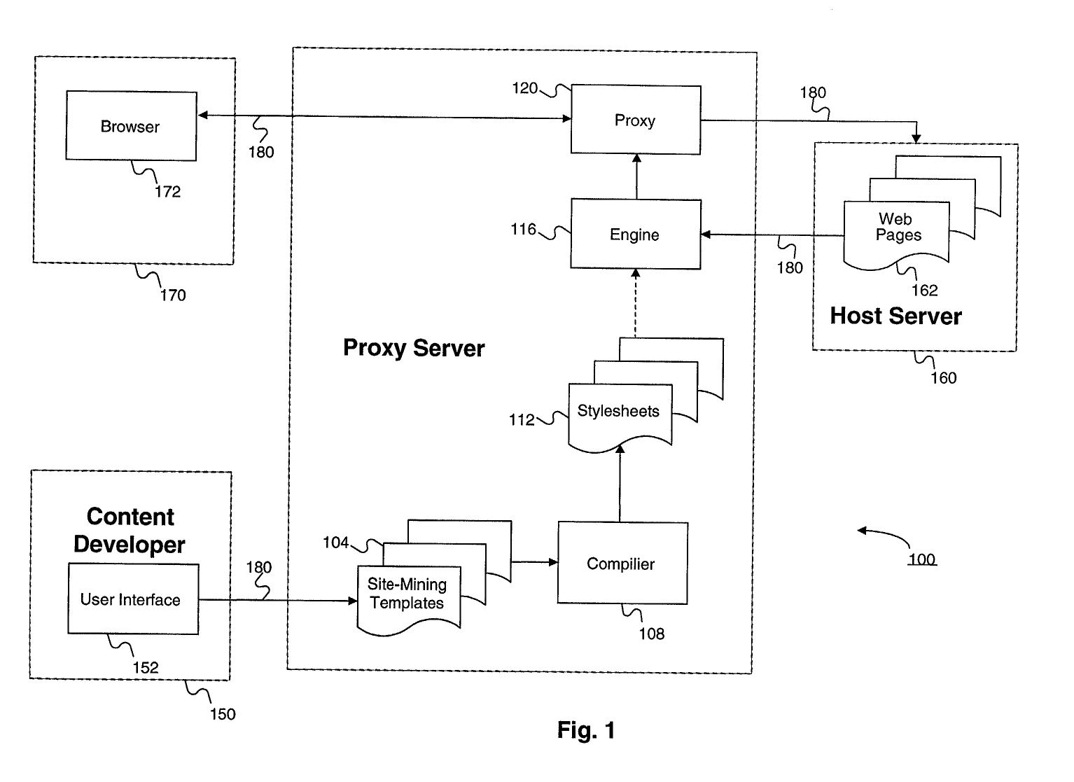

FIG. 1 illustrates an architecture utilizable for implementing various aspects of the present invention. In the embodiment depicted in FIG. 1, a proxy server 100 is linked to and utilizable with a developer workstation 150, server 160 and mobile device 170. Examples of proxy server 100 and server 160 include any of a number of mainframe and/or personal computing devices such as those utilizing Enterprise System Architecture/370 offered by International Business Machines Corporation of Armonk, N.Y. Examples of mobile device 170 may include any of a number of handheld devices such as those offered by Palm, Inc. of Santa Clara, Calif. including, for example, Palm VII devices. In addition, other examples of mobile device 170 may include any of a number of different types of computers, such as those having Pentium™-based processors manufactured by Intel Corporation of Santa Clara, Calif. Developer workstation 150, on the other hand, may exist as any of the computing devices discussed above. In addition, developer workstation 150 may also be implemented as one or more computing routines processing on proxy server 100. In this manner, embodiments of the present invention contemplate that developer workstation 150 may be utilized in conjunction with proxy server 100 to generate site mining stylesheets, which, upon request from mobile device 170, may be applied to web pages maintained in server 160 to deliver customized content to mobile device 170.

Referring again to FIG. 1, proxy server 100, mobile device 170, server 160, and in some embodiments developer workstation 150, may be linked or interconnected with each another via one or more data communication networks 180. Examples of these data communication networks include hard-wired and wireless LANs/WANs, direct dial-up lines, the Internet, intranets, and the like. Thus, data or content contained in web sites or web pages 162 maintained on server 160 may be accessed via, for example, the Internet by mobile device 170. In particular, a browser process 172 implemented on mobile device 170 may be utilized to formulate a search request or query with, for instance, a search function or a Universal Resource Locator (URL). In turn, this request or query is received by server 160 (e.g., via a HyperText Transport Protocol (HTTP) or the like), which in response transmits the web page containing the requested data to mobile device 170. From there, browser 172 processes the results and displays the originally requested web page content. Typically, the web page is embodied in a HyperText Markup Language (HTML), Extensible Markup Language (XML), Wireless Markup Language (WML) file, or the like, and may include other component files such as sound (e.g., .wav) or graphics (e.g., .gif) files or the like. With markup language examples, embodiments of the present invention contemplate that content may include HTML or XML tags and any data or information located within, or delineated by, the beginning and ending tags of a tag instance. Furthermore, although only one mobile device 170 and server 160 are shown in the example of FIG. 1, it is to be understood that any number of mobile devices and servers may be utilized in accordance with the concepts of the present invention.

As contemplated by embodiments of the present invention, proxy server 100 facilitates the generation of site mining stylesheets, which, when applied to a source web page, may be used to manipulate and/or customize selected content retrieved from the source web page. These stylesheets contain various rules and/or instructions for transforming the presentation or structure of a web page or other document, and may include programs for formatting web pages as well as commands for transforming other information such as magazines and newsprint. In addition, proxy server 100 also facilitates the subsequent transmission of this new content to a requesting mobile device 170. Thus, these stylesheets, may be used to describe how a source page is to be presented on a destination device. By applying a stylesheet to a source page, the source layout and presentation of the source page may be transformed and/or manipulated without sacrificing device-independence. As will be discussed below, embodiments of the present invention contemplate that the generation of these sylesheets may be facilitated through use of one or more site mining templates.

Referring again to FIG. 1, a graphical user interface (GUI) 152 operating on or in conjunction with developer workstation 150 may be utilized to generate any number of site mining templates 104. As one example, these templates 104 may be written in XML and may be stored in memory accessible by proxy server 100. Templates 104 generally identify the content from a source page (e.g., one of web pages 162) that is to be displayed or manipulated, as well as how the content is to be displayed and/or manipulated. For example, the location of a particular piece of content may be identified within a template by one or more site mining expressions. These site mining expressions are typically utilized by the stylesheet to locate the content to be retrieved and may include, for example, an XPath or Document Object Model (DOM) expression. In this regard, XPath may be characterized as a language or string syntax for addressing or building addresses to specific parts of a web page (typically written in XML). Thus, an XPath or other similar expression may be used to specify the location of a document structure or content found in a web page when processing that information.

To customize the appearance and layout of a resultant destination page, template 104 may also be utilized to display (i.e., add) content not extracted from the source page as well. To manipulate or otherwise transform content selected from the source page, embodiments of the present invention contemplate that a number of custom tags may be included within template 104. As will be discussed below, these custom tags may include rules or command tags used to control processing of template 104, transformation tags used to manipulate the content, or any other similar tags and the like. After generating the site mining template 104, these templates may be converted by a compiler process 108 to produce a number of stylesheets. As one example, the stylesheet produced after compilation may be embodied in Extensible Stylesheet Transformation code (XSLT) or some other similar rendering vocabulary for describing the semantics of formatting information.

To utilize a stylesheet generated in the above manner, a search request or query is received from mobile device 170, in the form of, for example a decorated URL or proxy request. With a proxy request, a browser may be configured to send queries to, for example, a specific HTTP port on a specific proxy server. The proxy server listens on this port, which may be separate from the port used by a web server, and processes all queries it receives. In other cases, web page references and links contained in a destination page point to a proxy server's web page. The proxy web page accepts the desired web page as a parameter, and in this manner the proxy web page is “decorated” with a desired URL. In any event, the request is received by a proxy process 120 implemented in proxy server 100. Generally speaking, proxy process 120 acts as an intermediary between the device browser 172 and the server 160, and is responsible, in part, for receiving HTTP requests and transforming the requests into other formats. In this example, after receiving a request from mobile device 170, proxy process 120 calls an engine 116, which in turn, applies a stylesheet corresponding to the requested web page. In this regard, engine 116 retrieves the content specified by the stylesheet from a source web page 162. From there, any transformations are performed by engine 116 before producing a “destination page”, which is then transmitted to a browser process 172 on the requesting mobile device 170. In this manner, selected content mined from a source page may be displayed in a customized format on a requesting mobile device.

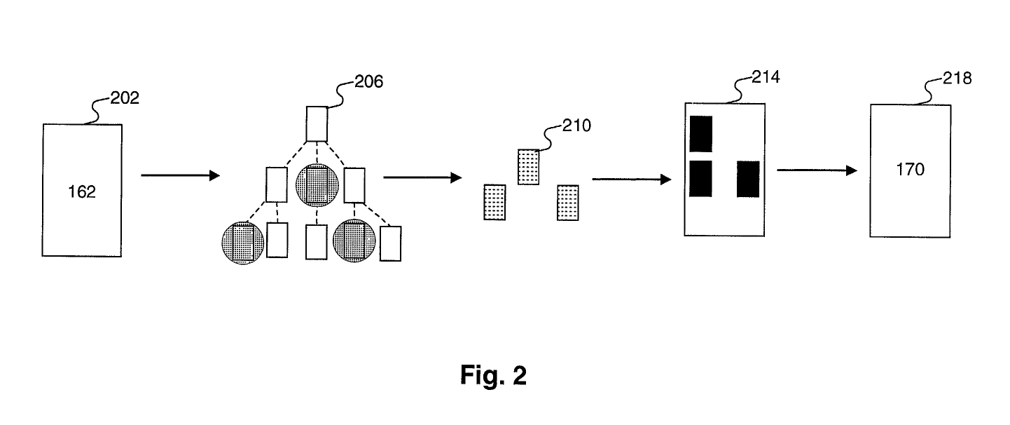

Referring to FIG. 2 (in conjunction with FIG. 1), one example of a process utilizable for generating and implementing a stylesheet of the present invention is described. Initially, a web page 162 requested by mobile device 170 is retrieved by proxy server 100 from server 160 (step 202). Subsequently, a corresponding stylesheet maintained on proxy server 100 is applied to web page 162 by engine 116 (step 206). As described above, the stylesheet may identify any number of pieces of content to be extracted from web page 162, via, for example, one or more site mining expressions (e.g., via XPath expressions or the like). Upon applying the stylesheet to web page 162, each identified piece of content may be extracted from the original source page (step 210). From there, each piece of content may be manipulated or otherwise transformed and inserted into a new or destination document along with any additional information specified by the stylesheet (step 214). This resulting destination document or web page may then be transmitted to the requesting remote device 170 (step 218).

As mentioned above, embodiments of the present invention provide a mechanism for selecting content from an original web page and for creating a site-mining template in which manipulations and formatting of the selected content may be performed. The syntax of the site-mining template is typically tag-based, utilizing any number of standard tags (including those offered with HTML, XML, or the like) as well as a variety of custom tags for manipulating the content. These custom tags may be implemented to provide any number of basic programming constructs including variables, looping, conditional and output statements, or the like. In addition, links (i.e., site mining expressions) to the content to be extracted may be placed at any number of desired locations within the template. In particular, an expression for locating content to be extracted may be determined or generated utilizing, for example, a visual process via a graphical user interface or the like. As will be discussed below, upon completing this process, a unique expression is generated, which may then be added to the template. From there, the template may be converted or compiled to produce, for example, an XLST stylesheet. Then, when the original web page is requested by a mobile device, this stylesheet may be applied to the requested page to produce a new destination page containing content that has been reformatted or manipulated to meet the specific requirements of the requesting mobile device.

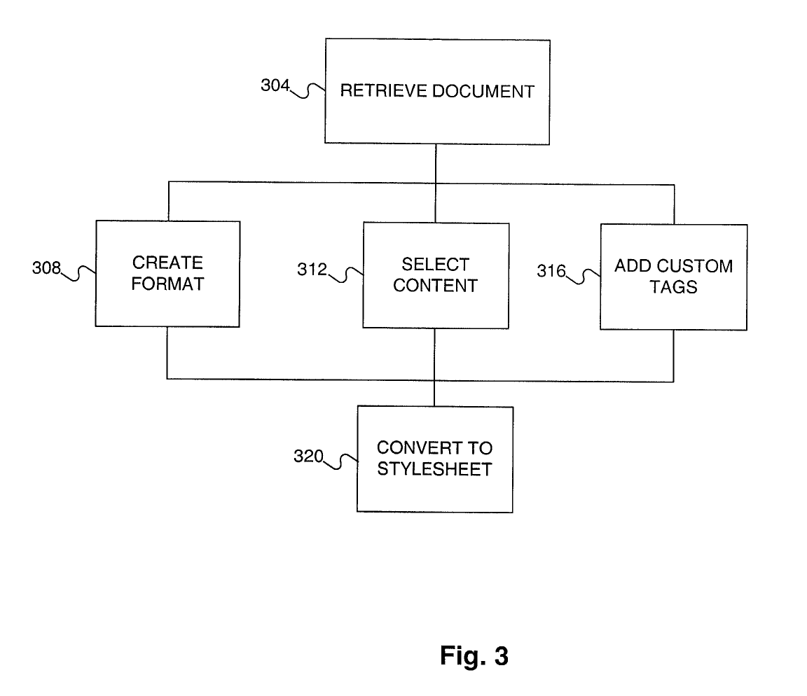

One example of a process utilizable for generating a site-mining stylesheet of the present invention is described with reference to FIG. 3. Initially, the source web page (i.e., the HTML or XML page to be site mined) is specified and retrieved by a developer (step 304). For instance, the URL of the document to be site mined may be entered at developer workstation 150 via a graphical user interface (GUI), or the like. The specified page is retrieved and, if not already in compliance with XML, may be converted to XHTML or some other XML-compliant format. In this regard, any number of software packages, such as Tidy offered by W3C, may be utilized to convert HTML documents to XML-compliant form.

Subsequently, a site mining template is generated for mining the source page. Specifically, working from, for example, developer workstation 150, the format or layout of the destination page may be designed using any combination of HTML or XML tags or the like (step 308). For instance, a developer may add any number of banners, determine header/footer settings/content, set margins, create new tables, add custom text or graphics and the like. In addition, embodiments of the present invention contemplate that any number of pieces of content may be selected for extraction, or mined, from the source page and included in some form in the template (step 312). As will be discussed below, for each piece of content to be extracted, an expression uniquely identifying or locating the content is generated. Embodiments of the present invention contemplate that these expressions may be embodied as XPath or DOM syntax expressions or any other site mining expressions utilizable for locating content in a web page written in an extensible markup language such as XML or the like. Other examples of extensible markup languages include Math Markup Language (MATHML), Bioinformatic Sequence markup language (BSML), Instrumentation Markup Language (IML), Chemical Markup Language (CML), Wireless Markup Language (WML), Astronomical Instrumentation Markup Language (AIML), and other similar markup languages. Furthermore, any number of custom tags may also be included in the template at this point (step 316). These tags may be utilized to manipulate or transform the extracted content as well as control the processing flow of the template. For instance, any number of command tags, such as loops or if-then tags, may be included to control flow during template processing. Likewise, any number of rules tags may be included to transform or otherwise manipulate selected content. Some examples of these transformations and manipulations include string or graphics replacement, string or graphics formatting, appending data to strings or graphics, reading data and performing additional functions, arithmetic/mathematical manipulations such as rounding, max/min, counting, summations and/or other similar manipulations. In this manner, the custom tags provide programming capability in the stylesheet.

During the template generation process, any format information, custom tags, and site mining expressions may be stored or saved to memory (e.g., in a .asl file) implemented in or accessible by proxy server 100. Examples of other possible custom tags include:

| Custom Tag | Attributes | Comment |
|---|---|---|
| Storage Tags | | |
| as-variable | name, | <pattern> is the unique XPath expression |
| | pattern | for content to extract. <name> is the name |
| | | of the variable where the content will be |
| | | copied. |
| as-query | name, | <pattern> is the unique XPath expression |
| | pattern | for content to link. <name> is the name of |
| | | the query where the content will be linked. |
| Decision Tags | | |
| as-if | condition | <condition> is a valid XPath expression. |
| | | If the expression is evaluated to True, |
| | | then the content contained in the tag is |
| | | copied to the stylesheet |
| Looping Tags | | |
| as-foreach | name, | <query> is an XPath expression for |
| | query | content as a query defined by as-query. |
| | | The tag causes the nested tags it contains |
| | | to be executed for each element that |
| | | <query> points to. The value of |
| | | the current iteration is stored in a |
| | | query named <name> |
| Search Tags | | |
| as-find | name, | <select> may be a variable, query, |
| | select, | or XPath link to content. <pattern> |
| | pattern | is a valid XPath expression. The tag |
| | | searches the content identified by <select> |
| | | for elements that match the <pattern> |
| | | expression. The results of the search are |
| | | stored in a variable named <name> |
| Rule Tags | | |
| as-applyrules | name, | <query> is an XPath expression for |
| | query | content or a query defined by as-query. |
| | | This tag copies the content specified by |
| | | <query> to a variable named |
| | | <name>. The rules contained by tag |
| | | are applied while the content is being |
| | | copied. |
| as-removeattr | pattern | <pattern> is a valid XPath expression. |
| | | Removes all attributes that match this |
| | | expression during the content copying. |
| as-editattr | pattern, | <pattern> is a valid XPath expression. |
| | [value, | This tag edits all attributes that match this |
| | scale, min, | expression during the content copying. |
| | max] | The attribute’s value is set if <value> |
| | | is specified. Otherwise the attributes’s |
| | | value is scaled and check against the |
| | | minimum and maximum boundaries. |
| Output Tags | | |
| as-output | select | <select> may be a variable, query, or |
| | | XPath link to content. Performs a deep |
| | | copy of the <select>’s content to the |
| | | stylesheet. |
| as-text | | Copies the content contained within the |
| | | tag to the stylesheet |
| Function Tags | | |
| as-function | name | Defines a function named <name>. Can be |
| | | immediately followed by zero or more |
| | | as-parameter tags. |
| as-parameter | name | Defines a parameter for the as-function tag |
| as-callfunc | name | Calls a function defined by as-function, |
| | | with the name <name>. Can be |
| | | immediately followed by zero or more |
| | | as-callparam tags. |
| as-callparam | name, | Passes a parameter with name <name> to |
| | select | a function defined by as-function. The |
| | | value of <select> may be a variable, |
| | | query, or XPath link to content. |

The exemplary custom tags listed above are utilizable in conjunction with XPath expression syntax. In addition, other custom tags, in addition to those listed above may also be implemented. Furthermore, it is to be understood that other types of site-mining expressions in addition to XPath expressions are also utilizable without departing from the scope of the present invention. Although the above examples describe the application of a stylesheet to a single web page, it is to be understood that embodiments of the present invention also contemplate the application of a stylesheet to any number of web pages conforming to certain specifications.

Referring again to FIG. 3, after the site-mining template has been designed, the template may be converted into a stylesheet by compiler 108 (step 320). Embodiments of the present invention contemplate that the end result of the conversion process may be an XSLT stylesheet in which any custom tags have been converted into a XSLT format (e.g., a .xsl file), although other similar types of stylesheets (e.g., cascading stylesheets) are also possible. As discussed above, after conversion, the stylesheet exists in a format readable and implementable by engine 116 to mine content from a source web page maintained on server 160. In addition, embodiments of the present invention contemplate the usage of XLST stylesheets for the conversion of the site mining template. In this regard, since the site mining template may be XML compliant, a XSLT stylesheet may act as the compiler, which converts the site mining template into a site mining stylesheet. One example of such a conversion procedure, utilizing a two-pass process, will be discussed in greater detail below.

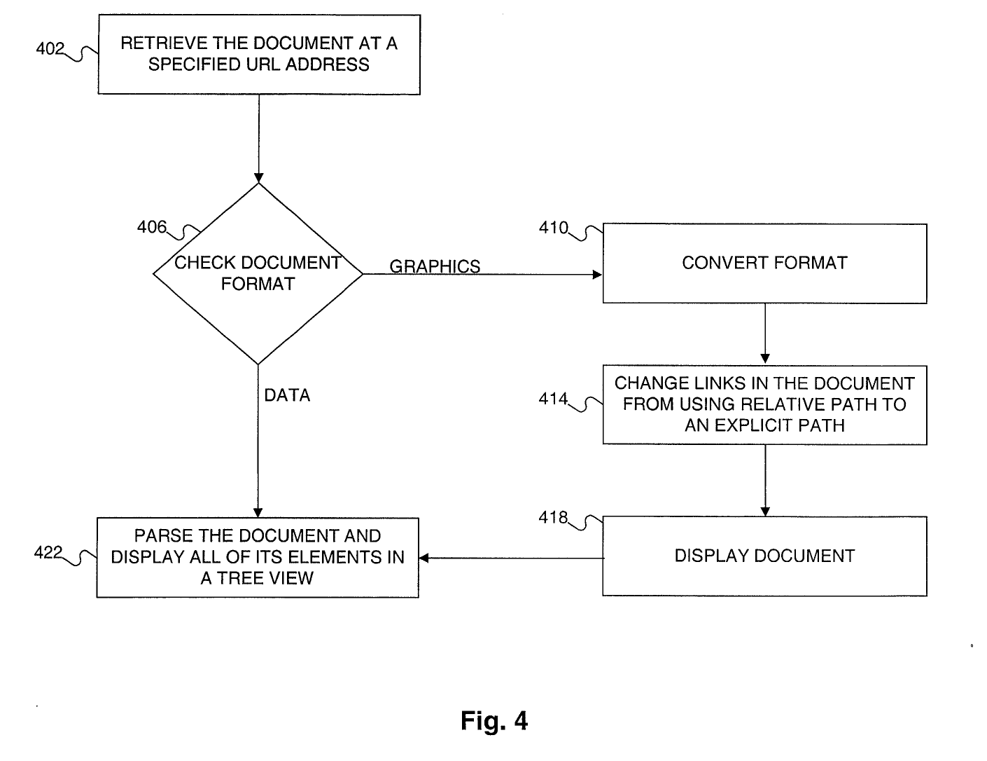

Examples of a number of processes utilizable for generating site-mining expressions utilizable for uniquely locating or identifying web page content are now described. In this regard, embodiments of the present invention contemplate that any combination of these processes may be used to generate the expressions utilized in step 312 of the stylesheet generation process discussed above. Referring now to FIG. 4, one example of a process utilizable for displaying one or more pieces of content contained by a web page is depicted. To commence processing, a web page containing the content at issue may be identified or specified using, for example, GUI 152 implemented on developer workstation 150. For instance, a developer may enter a URL specifying a web page from which content is to be extracted. The web page specified by the developer may then be retrieved (step 402). Embodiments of the present invention contemplate that the web page may be written in HTML, XML, or other similar languages. This being the case, the retrieved web page is then examined to determine its format (step 406). If the web page is embodied in a data or text-based format such as XML, the page may be parsed with its hierarchy of elements (i.e., content) displayed in, for example, a tree view (step 422). While displayed in this tree view, each piece of content may be displayed in relation to each of the other pieces of content contained in the page.

If, on the other hand, the web page is embodied in a HTML or some other graphics-based format, the page is converted into an XML compatible format such as XHTML (step 410). As mentioned above, any number of software packages, such as Tidy offered by W3C, may be utilized to convert HTML documents to XML-compliant form. Once the page has been converted into an XML-compliant form, the web page relative links are converted to an explicit path or absolute links (step 414). This may be accomplished using any number of procedures, one example of which is discussed in the Internet Engineering Task Force RFC 1808. Subsequently, the now XML compatible web page may be displayed (step 418) along with its hierarchy of elements in, for example, a tree view (step 422).

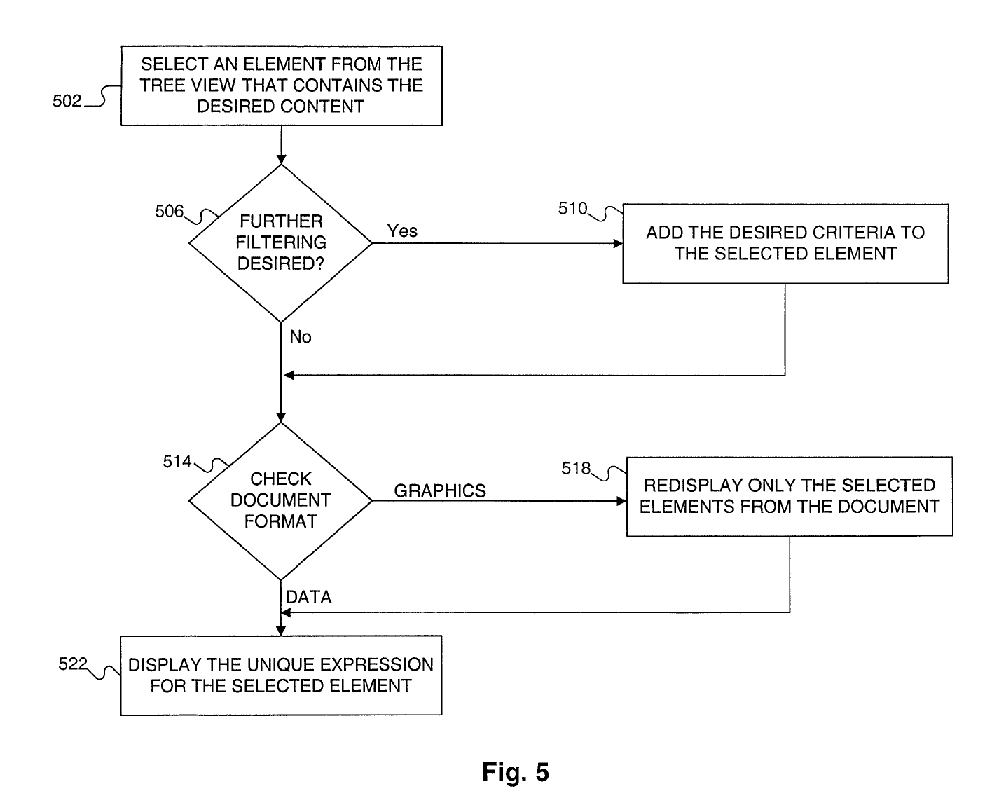

FIG. 5 depicts one example of a process utilizable for generating an expression for uniquely locating content selected from a web page. First, web page content may be selected from, for example, the tree view displayed as per step 422 (step 502). As an example, a developer may select content from a tree view displayed in GUI 152 by left or right clicking with a mouse on the element. For instance, the present invention may be implemented in a manner which allows the selection of a single piece of content with a left click. In a similar manner, right clicking may be arranged to allow more complex selections such as selecting each similarly named sibling (i.e., each element residing at a particular level in the tree); each similarly named piece of content in the page; each sibling element; or applying additional filtering criteria (e.g., content that contains specific text). Thus, the present invention may be utilized to select each piece of content identified by a HTML “TABLE” tag residing in a particular level. As such, if filtering is desired (step 506), the desired filtering criteria may be added to the selected element (step 510) by, for example, right clicking on the content and entering the criteria in a pop-up window, pulldown menu, or other user interface.

Referring again to FIG. 5, embodiments of the present invention contemplate that the selection of a particular piece of content may result in the updated display of any graphical components associated with the content. Thus, before any content is displayed, the format of the web page may be examined to determine whether any graphical components exist, by, for example, determining whether the document is in a graphics based or HTML format (step 514). If no graphical components exist in the page, the unique expression for the selected content is determined (discussed below) and displayed (step 522). If the page includes graphical components, the selected content may be displayed on GUI 152 (step 518) before determining and displaying the unique expression corresponding to the selected content (step 522). Thus, any HTML coded content may be displayed by utilizing, for example, a stylesheet or some other similar mechanism, to copy selected content and any child elements or text to GUI 152.

To generate an expression for locating content within a page, embodiments of the present invention contemplate identifying a unique expression for each piece of desired content within the page. Since pages are sets of content (tags) nested within one another in a hierarchical manner, it is contemplated that this unique expression may be derived from the concatenation of expressions created by drilling down through this hierarchy. As discussed above, the expression basically specifies a path to a piece of content. Although embodiments of the present invention contemplate that the expression may be embodied as an XPath expression, other formats may also be utilized, including, for example a DOM expression.

Several examples illustrating the generation of an XPath expression are now described using the following as an original document:

<html>
<body>

<h1>Table 1</h1>
<table>

<tr><td>This is text for row one, table one</td></tr>
<tr><td>This is text for row two, table one</td></tr>

</table>
<h1>Table 2</h1>
<table>

<tr><td>This is text for row one, table two</td></tr>
<tr><td>This is text for row two, table two</td></tr>

</table>

</body>
</html>
Example 1: Selecting a specific tag instance (using an index)
XPath Expression -

| | |
|---|---|
| /html/body/table[1]/tr[1] | = => Select the first row in the first table |

Corresponding Content -
<tr><td>This is text for row one, table one</td></tr>
Example 2: Select all sibling tags that have the same name
XPath Expression -

| | |
|---|---|
| /html/body/table[1]/tr | = => Select all rows in the first table |

Corresponding Content -
<tr><td>This is text for row one, table one</td></tr>
<tr><td>This is text for row two, table one</td></tr>
Example 3: Select all tags in the document that have the same name
XPath Expression -

| | |
|---|---|
| //tr | = => Select all rows |

Corresponding Content -
<tr><td>This is text for row one, table one</td></tr>
<tr><td>This is text for row two, table one</td></tr>
<tr><td>This is text for row one, table two</td></tr>
<tr><td>This is text for row two, table two</td></tr>
Example 4: Select all child elements regardless of name
XPath Expression -

| | |
|---|---|
| /html/body/* | = => Get all children of the html body |

Corresponding Content -
<h1>Table 1</h1>
<table>

<tr><td>This is text for row one, table one</td></tr>
<tr><td>This is text for row two, table one</td></tr>

</table>
<h1>Table 2</h1>
<table>

<tr><td>This is text for row one, table two</td></tr>
<tr><td>This is text for row two, table two</td></tr>

</table>
Applicable to all cases: Using expression filtering
XPath Expression-

| | |
|---|---|
| //td[contains(text( ), “table one)] | = => Get all table cells in the |

document that contain the text ‘table one’
Corresponding Content -
<td>This is text for row one, table one</td>
<td>This is text for row two, table one</td>

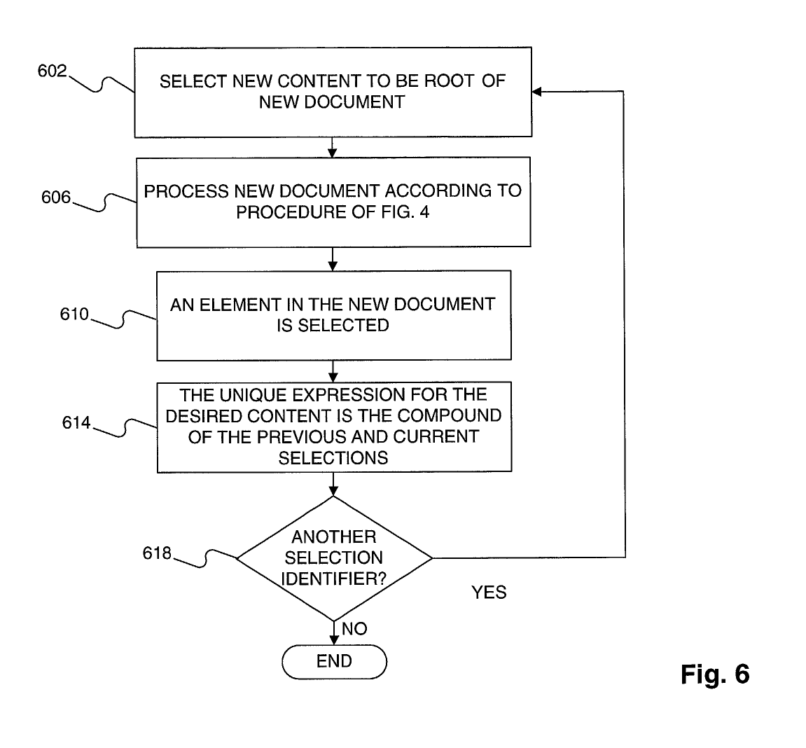

An example of a process for generating an expression for uniquely locating content selected from a web page, in which multiple selection are utilized, is described with reference to FIG. 6. In this compound selection example, content may be extracted based upon the concatenation or combination of a plurality of site mining expressions. Initially, this process starts by indicating that a currently selected piece of content is to be root element of a new document or page to be searched (step 602). This new document is created and processed according to the process described in FIG. 4, resulting in the display of its pieces of content in tree view (step 606). Subsequently, a piece of content from this new document or page may be selected and processed according to the process described in FIG. 5 to produce an expression locating the selected content within the new page (step 610). To generate a final expression, the expression used to locate the content within the new page is appended to or concatenated with the expression of the current page selected in step 602 (step 614). This process may be repeated as many times as desired (step 618). Thus, utilizing the process of FIG. 6, an expression may be generated to locate content which may move from place to place within a single structure. For example, the process of FIG. 6 may be used to generate an expression for locating a particular best-selling book within a best-selling book table (listed and updated according to the number of sales each week) by first selecting the table as the current selection, and then by entering the name of the book as additional filtering criteria. Hence, although the position of the table may shift within the document and the position of the book may shift within the table from week-to-week, an expression for locating the selected content (the book) may still be generated.

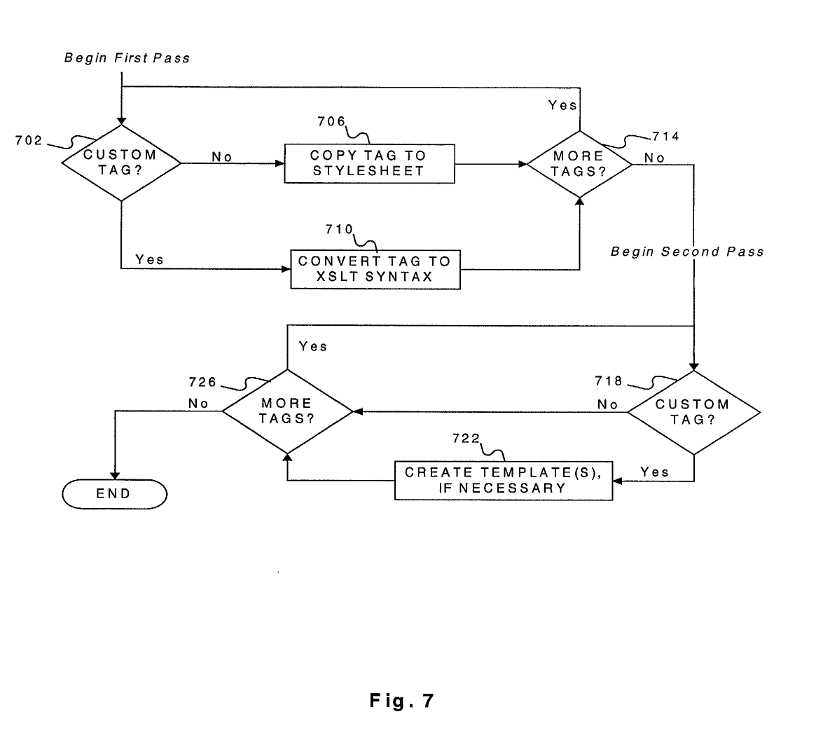

One example for converting the template into a stylesheet is now described with reference to FIG. 7. As mentioned above, embodiments of the present invention contemplate that compiler 108 may be used to convert a template into a stylesheet via, for example, a two pass process. Although the example depicted in FIG. 7 illustrates the conversion of a template into a XSLT stylesheet, as mentioned above, other stylesheets may also be produced. In addition, single pass and other multiple pass processes may also be utilized. Referring to FIG. 7, the first pass is responsible for creating a main body of the stylesheet. During this pass, any custom tags (step 702) may be replaced with equivalent XSLT syntax (step 710). Non-custom tags, on the other hand, are copied directly onto the stylesheet (step 706). This process is repeated until each tag in the template has been evaluated (step 714).

The second pass allows the custom tags to create any additional XSLT syntax that is required outside of the stylesheet's main body. For example, this may be required for custom tags that use the XSLT command, xsl:apply-templates. The templates used by this and other similar commands are typically located outside the main body and may be created at this time, if necessary (step 722). Non-custom tags are generally applicable to the main body and may therefore be ignored during this step. Again this process is repeated until each tag in the template has been evaluated (step 726).

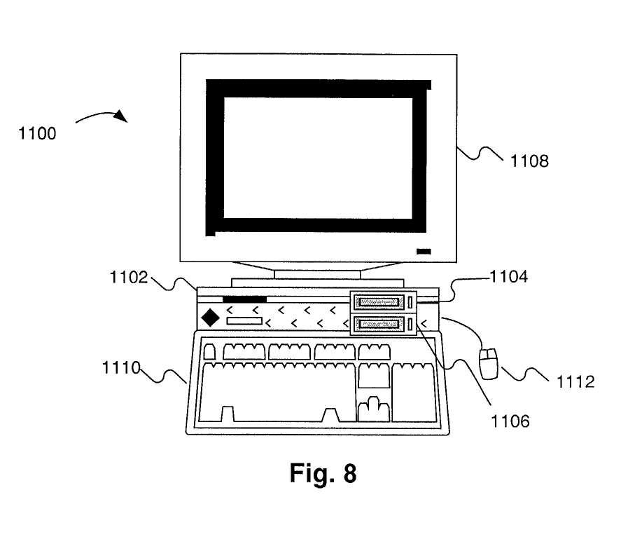

The techniques of the present invention may be implemented on a computing unit such as that depicted in FIG. 8. In this regard, FIG. 8 is an illustration of a computer system which is also capable of implementing some or all of the computer processing in accordance with computer implemented embodiments of the present invention. The procedures described herein are presented in terms of program procedures executed on, for example, a computer or network of computers.

Viewed externally in FIG. 8, a computer system designated by reference numeral 1100 has a computer portion 1102 having disk drives 1104 and 1106. Disk drive indications 1104 and 1106 are merely symbolic of a number of disk drives which might be accommodated by the computer system. Typically, these would include a floppy disk drive 1104, a hard disk drive (not shown externally) and a CD ROM indicated by slot 1106. The number and type of drives vary, typically with different computer configurations. Disk drives 1104 and 1106 are in fact optional, and for space considerations, are easily omitted from the computer system used in conjunction with the production process/apparatus described herein.

The computer system also has an optional display 1108 upon which information may be displayed. In some situations, a keyboard 1110 and a mouse 1112 are provided as input devices through which input may be provided, thus allowing input to interface with the central processing unit 1102. Alternatively, for enhanced portability, the keyboard 1110 is either a limited function keyboard or omitted in its entirety. In addition, mouse 1112 optionally is a touch pad control device, or a track ball device, or even omitted in its entirety as well, and similarly may be used as an input device. In addition, the computer system 1100 may also optionally include at least one infrared (or radio) transmitter and/or infrared (or radio) receiver for either transmitting and/or receiving infrared signals.

Although computer system 1100 is illustrated having a single processor, a single hard disk drive and a single local memory, the system 1100 is optionally suitably equipped with any multitude or combination of processors or storage devices. Computer system 1100 may be replaced by, or combined with, any suitable processing system operative in accordance with the principles of the present invention, including hand-held, laptop/notebook, mini, mainframe and super computers, as well as processing system network combinations of the same.

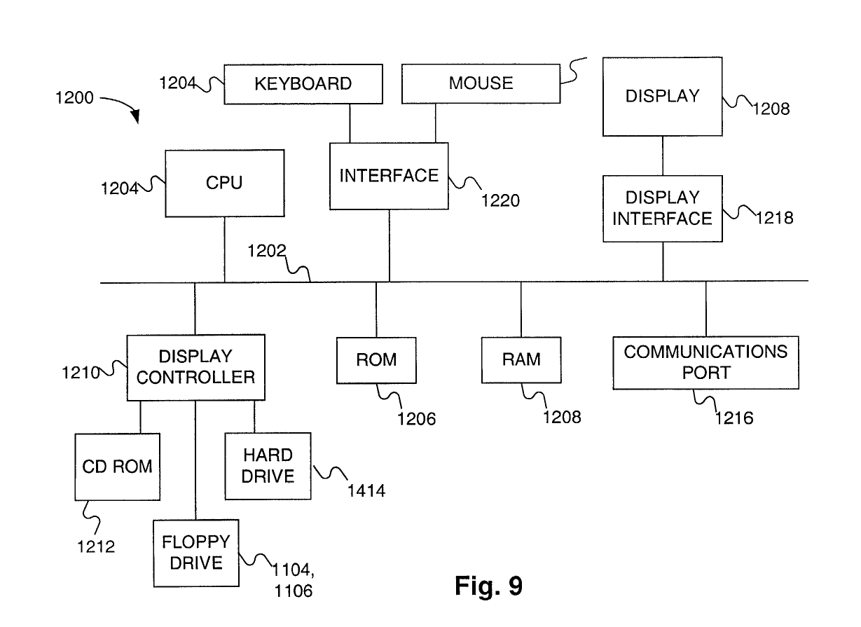

FIG. 9 illustrates a block diagram of exemplary internal hardware of the computer system 1100 of FIG. 8. A bus 1202 serves as the main information highway interconnecting the other components of the computer system 1100. CPU 1204 is the central processing unit of the system, performing calculations and logic operations required to execute a program. Read only memory (ROM) 1206 and random access memory (RAM) 1208 constitute the main memory of the computer 1102. Disk controller 1210 interfaces one or more disk drives to the system bus 1202. These disk drives are, for example, floppy disk drives such as 1104 or 1106, or CD ROM or DVD (digital video disks) drive such as 1212, or internal or external hard drives 1214. As indicated previously, these various disk drives and disk controllers are optional devices.

A display interface 1218 interfaces display 1208 and permits information from the bus 1202 to be displayed on the display 1108. Again as indicated, display 1108 is also an optional accessory. For example, display 1108 could be substituted or omitted. Communications with external devices, for example, the other components of the system described herein, occur utilizing communication port 1216. For example, optical fibers and/or electrical cables and/or conductors and/or optical communication (e.g., infrared, and the like) and/or wireless communication (e.g., radio frequency (RF), and the like) can be used as the transport medium between the external devices and communication port 1216. Peripheral interface 1220 interfaces the keyboard 1110 and the mouse 1112, permitting input data to be transmitted to the bus 1202.

In alternate embodiments, the above-identified CPU 1204, may be replaced by or combined with any other suitable processing circuits, including programmable logic devices, such as PALs (programmable array logic) and PLAs (programmable logic arrays). DSPs (digital signal processors), FPGAs (field programmable gate arrays), ASICs (application specific integrated circuits), VLSIs (very large scale integrated circuits) or the like.

One of the implementations contemplated by embodiments of the present invention is as sets of instructions resident in the random access memory 1208 of one or more computer systems 1100 configured generally as described above and/or as a transmission (e.g., digital signals). Until required by the computer system, the set of instructions may be stored in another computer readable memory, for example, in the hard disk drive 1214, or in a removable memory such as an optical disk for eventual use in the CD-ROM 1212 or in a floppy disk for eventual use in a floppy disk drive 1104, 1106. Further, the set of instructions (such as those written in the Java programming language) can be stored in the memory of another computer and transmitted in a transmission means such as a local area network or a wide area network such as the Internet 180 when desired by the user. One skilled in the art knows that storage or transmission of the computer program product changes the medium electrically, magnetically, or chemically so that the medium carries computer readable information.

In general, it should be emphasized that the various components of embodiments of the present invention can be implemented in hardware, software, or a combination thereof. In such embodiments, the various components and steps would be implemented in hardware and/or software to perform the functions of the present invention. Any presently available or future developed computer software language and/or hardware components can be employed in such embodiments of the present invention. For example, at least some of the functionality mentioned above could be implemented using Java, C, or C++ programming languages.

It is also to be appreciated and understood that the specific embodiments of the invention described hereinbefore are merely illustrative of the general principles of the invention. Various modifications may be made by those skilled in the art consistent with the principles set forth hereinbefore.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention. While the foregoing invention has been described in detail by way of illustration and example of preferred embodiments, numerous modifications, substitutions, and alterations are possible without departing from the scope of the invention defined in the following claims.

Having thus described my invention, what I claim as new and desire to secure by letters patent is as follows:

1. A method for extracting and transforming content from a source page for transmission to a mobile device, said method comprising the steps of:
(1) generating a stylesheet, wherein said stylesheet includes information indicating the content to be extracted from said source page and transformation information for manipulating the content;
(2) receiving, from the mobile device, a request to display said source page;
(3) applying said stylesheet to said source page to produce a destination page, wherein said destination page includes said extracted content to manipulated according to said transformation information; and
4) transmitting said destination page to said mobile device.

2. The method of claim 1, wherein step 3 comprises the steps of:
(1) retrieving said source page from a web server; and
(2) identifying said content to be extracted using a site mining expression.

3. The method of claim 1, further comprising the step of determining a site mining expression for uniquely locating said content to be extracted.

4. The method of claim 1, wherein step 1 comprises the steps of:
(1) receiving and storing to a site mining template said information indicating said content to be extracted and said transformation information for manipulating the content; and
(2) compiling said template to produce said stylesheet.

5. The method of claim 1, wherein said source page comprises a XML compliant document.

6. The method of claim 1, wherein said source page comprises a HTML document.

7. A method for generating a stylesheet, said method comprising the steps of:
(1) receiving an indication of an item of content to be extracted from a source page containing one or more items of content;
(2) determining an expression for uniquely locating said item of content to be extracted;
(3) receiving transformation information for manipulating said item of content;
(4) storing said transformation information and said expression to a site mining template; and
(5) converting said transformation information and said expression stored in said template to a stylesheet utilizable for mining content from said source page to produce a destination page containing said extracted content.

8. The method of claim 7, further comprising the step of receiving format information for formatting a layout of the stylesheet.

9. The method of claim 7, further comprising the steps of:
(1) receiving an indication of said source page;
(2) retrieving said source page; and
(3) displaying said one or more items of content contained in said source page for allowing a selection of said content to be extracted.

10. The method of claim 7, wherein said transformation information includes procedural tags for controlling a processing routine in said stylesheet.

11. The method of claim 7, wherein said transformation information includes transformation tags for manipulating content extracted from said source page in said stylesheet.

12. The method of claim 7, wherein said item of content is delineated by one or more tags.

13. The method of claim 7, wherein step 5 comprises the step of compiling said template with a two pass compilation process, wherein a first pass generates a main body of said stylesheet and a second pass generates commands located outside of said main body.

14. The method of claim 7, wherein step 2 further comprises the step of receiving filtering criteria for indicating content to be extracted, wherein said criteria includes at least one of: selecting a single item of content located at a particular position, siblings of said item of content, similarly named siblings of said item of content, similarly named items of content located anywhere within said source page, and content containing specific text.

15. The method of claim 7, wherein step 2 further comprises the steps of:
(1) receiving an indication of a root element; and
(2) displaying content stemming from said root element, wherein said content to be extracted is selected from said item of content stemming from said root element, and wherein said expression is determined by combining an expression locating said root element with an expression locating said selected content relative to said root element.

16. The method of claim 7, wherein said source page comprises a XML compliant document.

17. The method of claim 7, wherein said source page comprises a HTML document.

18. The method of claim 7, wherein said expression comprises an XPath syntax expression.

19. The method of claim 7, wherein said stylesheet includes a XSLT stylesheet.

20. A method for generating a site mining expression for use in locating one item of content of a plurality of items of content contained in a source page, said method comprising the steps of:
(1) displaying said plurality of items of content on a graphical user interface hierarchically in tree view form;
(2) receiving a selection for said one item of content, wherein said one item of content is to be extracted from said source page;
(3) displaying any graphical components of said one item of content selected in step 2; and
(4) generating a site mining expression for locating said one item of content in said source page, wherein said site mining expression is capable of locating content in a document written in an extensible markup language.

21. The method of claim 20, wherein said site mining expression comprises an XPath expression.

22. The method of claim 20, further comprising receiving the step of filtering criteria for indicating content to be extracted, wherein said criteria includes at least one of: selecting a single item of content located at a particular position, siblings of said item of content, similarly named siblings of said item of content, similarly named items of content located anywhere within said source page, and content containing specific text.

23. The method of claim 20, further comprising the steps of:
(1) receiving a designation of an item of content as a root element; and
(2) displaying items of content stemming from said root element, wherein said item of content to be extracted is selected from said item of content stemming from said root element, and wherein said expression is determined by combining an expression locating said root element with an expression locating said item of content to be extracted relative to said root element.

24. A system for extracting and transforming content from a source page for transmission to a mobile device, said system comprising:
a central computer comprising:
a processor utilizable for generating a stylesheet, wherein said stylesheet includes information indicating the content to be extracted from said source page and transformation information for manipulating the content;
an interface in communication with said processor for receiving, from the mobile device, a request to display said source page;
wherein, upon receiving said request, said processor applies said stylesheet to said source page to produce a destination page which includes said extracted content manipulated according to said transformation information; and
wherein said interface transmits said destination page to said mobile device.

25. The system of claim 24, wherein said processor applies said stylesheet by retrieving said source page from a web server; and by identifying said content to be extracted using a site mining expression.

26. The system of claim 24, wherein said processor is further capable of determining a site mining expression for uniquely locating said content to be extracted.

27. The system of claim 24, wherein said processor generates said stylesheet by:
receiving and storing to a site mining template said information indicating said content to be extracted and said transformation information for manipulating the content; and
compiling said template to produce said stylesheet.

28. The system of claim 24, wherein said source page comprises a XML compliant document.

29. The system of claim 24, wherein said source page comprises a HTML document.

30. A system for generating a stylesheet, said system comprising:
a central computer comprising:
an interface for receiving an indication of an item of content to be extracted from a source page containing one or more items of content and for receiving transformation information for manipulating said item of content;
a processor in communication with said interface, wherein said processor is capable of determining an expression for uniquely locating said item of content to be extracted;
a memory for storing a site mining template, said template including said transformation information and said expression; and
a compiler implementable by said processor for converting said transformation information and said expression stored in said template to a stylesheet utilizable for mining content from said source page to produce a destination page containing said extracted content.

31. The system of claim 30, wherein said interface is capable of:
receiving an indication of said source page;
retrieving said source page; and
transmitting said one or more items of content contained in said source page to a display for allowing a selection of said content to be extracted.

32. The system of claim 30, wherein said transformation information includes procedural tags for controlling a processing routine in said stylesheet.

33. The system of claim 30, wherein said transformation information includes transformation tags for manipulating content extracted from said source page in said stylesheet.

34. The system of claim 30, wherein said item of content is delineated by one or more tags.

35. The system of claim 30, wherein said compiler converts said information using a two pass compilation process, wherein a first pass generates a main body of said stylesheet and a second pass generates commands located outside of said main body.

36. The system of claim 30, wherein said processor determines said expression by receiving filtering criteria via said interface for indicating content to be extracted, wherein said criteria includes at least one of: selecting a single item of content located at a particular position, siblings of said item of content, similarly named siblings of said item of content, similarly named items of content located anywhere within said source page, and content containing specific text.

37. The system of claim 30, wherein said processor determines said expression by:
receiving, via said interface, an indication of a root element; and
transmitting content stemming from said root element to a display, wherein said content to be extracted is selected, using said display, from said item of content stemming from said root element, and wherein said expression is determined by combining an expression locating said root element with an expression locating said selected content relative to said root element.

38. The system of claim 30, wherein said source page comprises a XML compliant document.

39. The system of claim 30, wherein said source page comprises a HTML document.

40. The system of claim 30, wherein said expression comprises an XPath syntax expression.

41. The system of claim 30, wherein said stylesheet includes a XSLT stylesheet.

42. A system for generating a site mining expression for use in locating one item of content of a plurality of items of content contained in a source page, said system comprising:
a central computer comprising:
an interface for transmitting said plurality of items of content to a graphical user interface for hierarchically display in tree view form, said interface being capable of receiving a selection from said graphical user interface for said one item of content, wherein said one item of content is to be extracted from said source page, wherein upon receiving said selection said interface transmits any graphical components of said one item of content for display on said graphical user interface; and
a processor in communication with said interface and capable of generating a site mining expression for locating said one item of content in said source page, wherein said site mining expression is capable of locating content in a document written in an extensible markup language.

43. The system of claim 42, wherein said site mining expression comprises an XPath expression.

44. A system for extracting and transforming content from a source page for transmission to a mobile device, said system comprising:
a server comprising a processor and a memory, wherein said processor is capable of:
generating a stylesheet, wherein said stylesheet includes information indicating the content to be extracted from said source page and transformation information for manipulating the content;
receiving, from the mobile device, a request to display said source page;
applying said stylesheet to said source page to produce a destination page, wherein said destination page includes said extracted content manipulated according to said transformation information; and
transmitting said destination page to said mobile device.

45. The system of claim 44, wherein said processor is further capable of determining a site mining expression for uniquely locating said content to be extracted.

46. The system of claim 44, wherein said stylesheet is generated by:
receiving and storing to a site mining template said information indicating said content to be extracted and said transformation information for manipulating the content; and
compiling said template to produce said stylesheet.

47. A system for generating a stylesheet, said system comprising:
a server comprising a processor and a memory, wherein said processor is capable of:
receiving format information for formatting a layout of the stylesheet;
receiving an indication of an item of content to be extracted from a source page containing one or more items of content;
determining an expression for uniquely locating said item of content to be extracted;
receiving transformation information for manipulating said item of content;
storing said format information, said transformation information, and said expression to a site mining template; and
converting said transformation information and said expression stored in said template to a stylesheet utilizable for mining content from said source page to produce a destination page containing said extracted content.

48. The system of claim 47, wherein said transformation information includes transformation tags for manipulating content extracted from said source page in said stylesheet.

49. The system of claim 47, wherein said expression is determined by receiving filtering criteria for indicating content to be extracted, wherein said criteria includes at least one of: selecting a single item of content located at a particular position, siblings of said item of content, similarly named siblings of said item of content, similarly named items of content located anywhere within said source page, and content containing specific text.

50. The system of claim 47, wherein said expression is determined by:
receiving an indication of a root element; and
displaying content stemming from said root element, wherein said content to be extracted is selected from said item of content stemming from said root element, and wherein said expression is determined by combining an expression locating said root element with an expression locating said selected content relative to said root element.

51. A system for generating a site mining expression for use in locating one item of content of a plurality of items of content contained in a source page, said system comprising:
a server comprising a processor and a memory, wherein said processor is capable of:
displaying said plurality of items of content on a graphical user interface hierarchically in tree view form;
receiving a selection for said one item of content, wherein said one item of content is to be extracted from said source page;
displaying any graphical components of said one item of content; and
generating a site mining expression for locating said one item of content in said source page, wherein said site mining expression is capable of locating content in a document written in an extensible markup language.

52. The system of claim 51, wherein said processor is further capable of receiving filtering criteria for indicating content to be extracted, wherein said criteria includes at least one of: selecting a single item of content located at a particular position, siblings of said item of content, similarly named siblings of said item of content, similarly named items of content located anywhere within said source page, and content containing specific text.

53. The system of claim 51, wherein said processor is further capable of:
receiving a designation of an item of content as a root element; and
displaying items of content stemming from said root element, wherein said item of content to be extracted is selected from said item of content stemming from said root element, and wherein said expression is determined by combining an expression locating said root element with an expression locating said item of content to be extracted relative to said root element.

54. A computer program implemented on a computer-readable medium for extracting and transforming content from a source page for transmission to a mobile device, said program comprising:
computer-readable instructions for generating a stylesheet, wherein said stylesheet includes information indicating the content to be extracted from said source page and transformation information for manipulating the content;
computer-readable instructions for receiving, from the mobile device, a request to display said source page;
computer-readable instructions for applying said stylesheet to said source page to produce a destination page, wherein said destination page includes said extracted content manipulated according to said transformation information; and
computer-readable instructions for transmitting said destination page to said mobile device.

55. The computer program of claim 54, wherein said instructions for applying comprises:
computer-readable instructions for retrieving said source page from a web server; and
computer-readable instructions for identifying said content to be extracted using a site mining expression.

56. The computer program of claim 54, further comprising computer-readable instructions for determining a site mining expression for uniquely locating said content to be extracted.

57. The computer program of claim 54, wherein said instructions for generating further comprises:
computer-readable instruction for receiving and storing to a site mining template said information indicating said content to be extracted and said transformation information for manipulating the content; and
computer-readable instructions for compiling said template to produce said stylesheet.

58. The computer program of claim 54, wherein said source page comprises a XML compliant document.

59. The computer program of claim 54, wherein said source page comprises a HTML document.

60. A computer program implemented on a computer-readable medium for generating a stylesheet, said program comprising:
computer-readable instructions for receiving an indication of an item of content to be extracted from a source page containing one or more items of content;
computer-readable instructions for receiving determining an expression for uniquely locating said item of content to be extracted;
computer-readable instructions for receiving transformation information for manipulating said item of content;
computer-readable instructions for storing said transformation information and said expression to a site mining template; and
computer-readable instructions for converting transformation information b y and expression stored in said template to a stylesheet utilizable for mining content from said source page to produce a destination page containing said extracted content.

61. The computer program of claim 60, wherein said program further comprises:
computer-readable instructions for receiving an indication of said source page;
computer-readable instructions for retrieving said source page; and
computer-readable instructions for displaying said one or more items of content contained in said source page for allowing a selection of said content to be extracted.

62. The computer program of claim 60, wherein said transformation information includes procedural tags for controlling a processing routine in said stylesheet.

63. The computer program of claim 60, wherein said transformation information includes transformation tags for manipulating content extracted from said source page in said stylesheet.

64. The computer program of claim 60, wherein said item of content is delineated by one or more tags.

65. The computer program of claim 60, wherein said instructions for converting further comprises computer-readable instructions for compiling said template with a two pass compilation process, wherein a first pass generates a main body of said stylesheet and a second pass generates commands located outside of said main body.

66. The computer program of claim 60, wherein said instructions for determining an expression further comprises computer-readable instructions for receiving filtering criteria for indicating content to be extracted, wherein said criteria includes at least one of: selecting a single item of content located at a particular position, siblings of said item of content, similarly named siblings of said item of content, similarly named items of content located anywhere within said source page, and content containing specific text.

67. The computer program of claim 60, wherein said instructions for determining an expression further comprises a
computer-readable instructions for receiving an indication of a root element; and
computer-readable instructions for displaying content stemming from said root element, wherein said content to be extracted is selected from said item of content stemming from said root element, and wherein said expression is determined by combining an expression locating said root element with an expression locating said selected content relative to said root element.

68. The computer program of claim 60, wherein said source page comprises a XML compliant document.

69. The computer program of claim 60, wherein said source page comprises a HTML document.

70. The computer program of claim 60, wherein said expression comprises an XPath syntax expression.

71. The computer program of claim 60, wherein said stylesheet includes a XSLT stylesheet.

72. A computer program implemented on a computer-readable medium for generating a site mining expression for use in locating one item of content of a plurality of items of content contained in a source page, said program comprising:
computer-readable instructions for displaying said plurality of items of content on a graphical user interface hierarchically in tree view form;
computer-readable instructions for receiving a selection for said one item of content, wherein said one item of content is to be extracted from said source page;
computer-readable instructions for displaying any graphical components of A t) said one item of content; and
computer-readable instructions for generating a site mining expression for locating said one item of content in said source page, wherein said site mining expression is capable of locating content in a document written in an extensible markup language.

73. The computer program of claim 72, wherein said site mining expression comprises an XPath expression.

74. The computer program of claim 72, further comprising computer-readable instructions for receiving filtering criteria for indicating content to be extracted, wherein said criteria includes at least one of: selecting a single item of content located at a particular position, siblings of said item of content, similarly named siblings of said item of content, similarly named items of content located anywhere within said source page, and content containing specific text.

75. The computer program of claim 72, further comprising:
computer-readable instructions for receiving a designation of an item of content as a root element; and
computer-readable instructions for displaying items of content stemming from said root element, wherein said item of content to be extracted is selected from said item of content stemming from said root element, and wherein said expression is determined by combining an expression locating said root element with an expression locating said item of content to be extracted relative to said root element.

76. A system for extracting and transforming content from a source page for transmission to a mobile device, said system comprising:
means for generating a stylesheet, wherein said stylesheet includes information indicating the content to be extracted from said source page and transformation information for manipulating the content;
means for receiving, from the mobile device, a request to display said source page;
means for applying said stylesheet to said source page to produce a destination page, wherein said destination page includes said extracted content manipulated according to said transformation information; and
means for transmitting said destination page to said mobile device.

77. The system of claim 76, wherein said means for applying comprises:
means for retrieving said source page from a web server; and
means for identifying said content to be extracted using a site mining expression.

78. The system of claim 76, further comprising means for determining a site mining expression for uniquely locating said content to be extracted.

79. The system of claim 76, wherein said means for generating comprises:
means for receiving and storing to a site mining template said information indicating said content to be extracted and said transformation information for manipulating the content; and
means for compiling said template to produce said stylesheet.

80. The system of claim 76, wherein said source page comprises a XML compliant document.

81. The system of claim 76, wherein said source page comprises a HTML document.

82. A system for generating a stylesheet, said system comprising:
means for receiving an indication of an item of content to be extracted from a source page containing one or more items of content;
means for determining an expression for uniquely locating said item of content to be extracted;
means for receiving transformation information for manipulating said item of content;
means for storing said transformation information, and said expression to a site mining template; and
means for converting said transformation information and expression stored in said template to a stylesheet utilizable for mining content from said source page to produce a destination page containing said extracted content.

83. The system of claim 82, further comprising means for receiving format information for formatting a layout of said stylesheet, and means for storing said formation information to said template.

84. The system of claim 82, further comprising:
means for receiving an indication of said source page;
means for retrieving said source page; and
means for displaying said one or more items of content contained in said source page for allowing a selection of said content to be extracted.

85. The system of claim 82, wherein said transformation information includes procedural tags for controlling a processing routine in said stylesheet.

86. The system of claim 82, wherein said transformation information includes transformation tags for manipulating content extracted from said source page in said stylesheet.

87. The system of claim 82, wherein said item of content is delineated by one or more tags.

88. The system of claim 82, wherein said means for converting comprises means for compiling said template with a two pass compilation process, wherein a first pass generates a main body of said stylesheet and a second pass generates commands located outside of said main body.

89. The system of claim 82, wherein said means for determining comprises means for further comprises receiving filtering criteria for indicating content to be extracted, wherein said criteria includes at least one of: selecting a single item of content located at a particular position, siblings of said item of content, similarly named siblings of said item of content, similarly named items of content located anywhere within said source page, and content containing specific text.

90. The system of claim 82, wherein said means for determining further comprises:
means for receiving an indication of a root element; and
means for displaying content stemming from said root element, wherein said content to be extracted is selected from said item of content stemming from said root element, and wherein said expression is determined by combining an expression locating said root element with an expression locating said selected content relative to said root element.

91. The system of claim 82, wherein said source page comprises a XML compliant document.

92. The system of claim 82, wherein said source page comprises a HTML document.

93. The system of claim 82, wherein said expression comprises an XPath syntax expression.

94. The system of claim 82, wherein said stylesheet includes a XSLT stylesheet.

95. A system for generating a site mining expression for use in locating one item of content of a plurality of items of content contained in a source page, said system comprising:
means for displaying said plurality of items of content on a graphical user interface hierarchically in tree view form;
means for receiving a selection for said one item of content, wherein said one item of content is to be extracted from said source page;
means for displaying any graphical components of said one item of content; and
means for generating a site mining expression for locating said one item of content in said source page, wherein said site mining expression is capable of locating content in a document written in an extensible markup language.

96. The system of claim 95, wherein said site mining expression comprises an XPath expression.

97. The system of claim 95, further comprising means for receiving filtering criteria for indicating content to be extracted, wherein said criteria includes at least one of: selecting a single item of content located at a particular position, siblings of said item of content, similarly named siblings of said item of content, similarly named items of content located anywhere within said source page, and content containing specific text.

98. The system of claim 95, further comprising:
means for receiving a designation of an item of content as a root element; and
means for displaying items of content stemming from said root element, wherein said item of content to be extracted is selected from said item of content stemming from said root element, and wherein said expression is determined by combining an expression locating said root element with an expression locating said item of content to be extracted relative to said root element.
